(19) United States
(12) Patent Application Publication
(10) Pub. No.: US 2014/0122599 A1
(43) Pub. Date: May 1, 2014

(54) MOBILE TERMINAL AND CONTROLLING METHOD THEREOF

(71) Applicants: Yeongmi PARK, Seoul (KR); Haeju LEE, Seoul (KR); Sukhui KIM, Seoul (KR); Changik JEONG, Seoul (KR)

(72) Inventors: Yeongmi PARK, Seoul (KR); Haeju LEE, Seoul (KR); Sukhui KIM, Seoul (KR); Changik JEONG, Seoul (KR)

(21) Appl. No.: 14/064,734

(22) Filed: Oct. 28, 2013

(30) Foreign Application Priority Data
Oct. 29, 2012 (KR) 10-2012-0120427

(51) Int. Cl. H04L 29/06

(52) U.S. Cl. CPC H04L 65/403
USPC 709/204

(57) ABSTRACT

A mobile terminal and controlling method thereof are disclosed, which facilitates a terminal to be used in further consideration of user's convenience. The present invention includes connecting the host terminal and the mobile terminal to each other by wireless, transmitting an attendance request signal including an information on a conference start time to the mobile terminal from the host terminal, and transmitting saved virtual conference materials to the mobile terminal from the host terminal before the conference start time. Accordingly, virtual conference materials can be shared between mobile terminals participating in a virtual conference in advance of a conference time. And, in sharing virtual conference materials between mobile terminals participating in a virtual conference, if the virtual conference materials are modified or memos are inputted, the synchronized virtual conference materials can be shared.

### CROSS-REFERENCE TO RELATED APPLICATION(S)

Pursuant to 35 U.S.C. §119(a), this application claims the benefit of earlier filing date and right of priority to Korean Application No. 10-2012-0120427, filed on Oct. 29, 2012, the contents of which are hereby incorporated by reference herein in their entirety.

### BACKGROUND

1. Field

The present invention relates to a mobile terminal, and more particularly, to a mobile terminal and controlling method thereof. Although the present invention is suitable for a wide scope of applications, it is particularly suitable for facilitating a terminal to be used in further consideration of user's convenience.

2. Background

A mobile terminal is a device which may be configured to perform various functions. Examples of such functions include data and voice communications, capturing images and video via a camera, recording audio, playing music files and outputting music via a speaker system, and displaying images and video on a display. Some terminals include additional functionality which supports game playing, while other terminals are also configured as multimedia players. More recently, mobile terminals have been configured to receive broadcast and multicast signals which permit viewing of contents, such as videos and television programs.

Generally, terminals can be classified into mobile terminals and stationary terminals according to a presence or non-presence of mobility. And, the mobile terminals can be further classified into handheld terminals and vehicle mount terminals according to availability for hand-carry.

There are ongoing efforts to support and increase the functionality of mobile terminals. Such efforts include software and hardware improvements, as well as changes and improvements in the structural components which form the mobile terminal.

Recently, as an amount of data transceivable by a mobile terminal rapidly increases, many ongoing efforts are made to research and develop various services that can be provided using the mobile terminal.

Particularly, as an environment capable of exchanging data among multiple users is provided, the demand for a system capable of a virtual multi-user conference or lecture is rising.

### SUMMARY OF THE INVENTION

Accordingly, embodiments of the present invention are directed to a mobile terminal and controlling method thereof that substantially obviate one or more problems due to limitations and disadvantages of the related art.

One object of the present invention is to provide a mobile terminal and controlling method thereof, by which materials of a virtual conference can be shared in advance prior to a conference start time in performing the virtual conference with a plurality of mobile terminals connected to each other.

Another object of the present invention is to provide a mobile terminal and controlling method thereof, by which the following can be achieved. First of all, if virtual conference materials are modified or a memo is inputted before and/or in the course of the conference, the modified item or the inputted memo can be synchronized.

Additional advantages, objects, and features of the invention will be set forth in the disclosure herein as well as the accompanying drawings. Such aspects may also be appreciated by those skilled in the art based on the disclosure herein.

To achieve these objects and other advantages and in accordance with the purpose of the invention, as embodied and broadly described herein, a mobile terminal, which is capable of performing a remote virtual conference with a host terminal in case of being connected to the host terminal by wireless, according to one embodiment of the present invention may include a touchscreen, a wireless communication unit configured to transceive data with the host terminal, a memory unit configured to store virtual conference materials, and a controller, if receiving an attendance request signal including information on a conference start time from the host terminal, initiating a download of the virtual conference materials before the conference start time.

In another aspect of the present invention, a host terminal, which is capable of performing a virtual conference with a connected mobile terminal by being connected to at least one mobile terminal, according to another embodiment of the present invention may include a touchscreen, a wireless communication unit configured to transceive data with the mobile terminal, a memory unit configured to store virtual conference materials, and a controller transmitting an attendance request signal including an information on a conference start time to the connected mobile terminal, the controller initiating a transmission of the virtual conference materials to the mobile terminal before the conference start time.

In a further aspect of the present invention, a method of controlling a virtual conference system, which is capable of performing a remote virtual conference in a manner of connecting a host terminal and a mobile terminal to each other by wireless, according to a further embodiment of the present invention may include the steps of connecting the host terminal and the mobile terminal to each other by wireless, transmitting an attendance request signal including an information on a conference start time to the mobile terminal from the host terminal, and transmitting saved virtual conference materials to the mobile terminal from the host terminal before the conference start time.

Effects obtainable from the present invention may be non-limited by the above mentioned effect. And, other unmentioned effects can be clearly understood from the following description by those having ordinary skill in the technical field to which the present invention pertains.

It is to be understood that both the foregoing general description and the following detailed description of the present invention are exemplary and explanatory and are intended to provide further explanation of the invention as claimed.

### BRIEF DESCRIPTION OF THE DRAWINGS

The embodiments will be described in detail with reference to the following drawings in which like reference numerals refer to like elements wherein:

FIG. 1 is a block diagram of a mobile terminal according to one embodiment of the present invention;

FIG. 2A is a front perspective diagram of a mobile terminal according to one embodiment of the present invention;

FIG. 2B is a rear perspective diagram of a mobile terminal according to one embodiment of the present invention;

FIG. 3 is a schematic diagram of a system capable of holding a virtual conference according to an embodiment of the present invention;

FIG. 4 is a diagram for one example of transmitting an attendance request signal to a participating terminal from a host terminal according to one embodiment of the present invention;

FIG. 5 is a diagram for one example of a method of making a request for changing a setting item of a conference according to one embodiment of the present invention;

FIG. 6 is a diagram for one example of a method of requesting an attendance per detailed subject or determining whether to attend per detailed subject according to one embodiment of the present invention;

FIG. 7 and FIG. 8 are diagrams for examples of synchronizing virtual conference materials between a host terminal and a participating terminal in a virtual conference system according to one embodiment of the present invention;

FIG. 9 is a diagram for one example of a state that a next page (page 2) turned by a user from a previous page of virtual conference materials is displayed on a host terminal 100-1;

FIG. 10 is a diagram for one example of a method of synchronizing an output of an indicator indicating a lecture progress level according to one embodiment of the present invention;

FIG. 11 is a diagram for one example that a host terminal 100-1 is outputting a memo 1101 inputted by a user together with virtual conference materials;

FIG. 12 is a diagram for one example of a method of displaying an overlaid memo layer according to one embodiment of the present invention;

FIG. 13 is a diagram for one example of a controlling method after closing a conference in a virtual conference system according to one embodiment of the present invention; and

FIG. 14A and FIG. 14B are flowcharts of a method of controlling a virtual conference system according to one embodiment of the present invention.

### DETAILED DESCRIPTION

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

As used herein, the suffixes ‘module’, ‘unit’ and ‘part’ are used for elements in order to facilitate the disclosure only. Therefore, significant meanings or roles are not given to the suffixes themselves and it is understood that the ‘module’, ‘unit’ and ‘part’ can be used together or interchangeably.

The present invention can be applicable to a various types of terminals. Examples of such terminals include mobile terminals, such as mobile phones, user equipment, smart phones, mobile computers, digital broadcast terminals, personal digital assistants, portable multimedia players (PMP) and navigators.

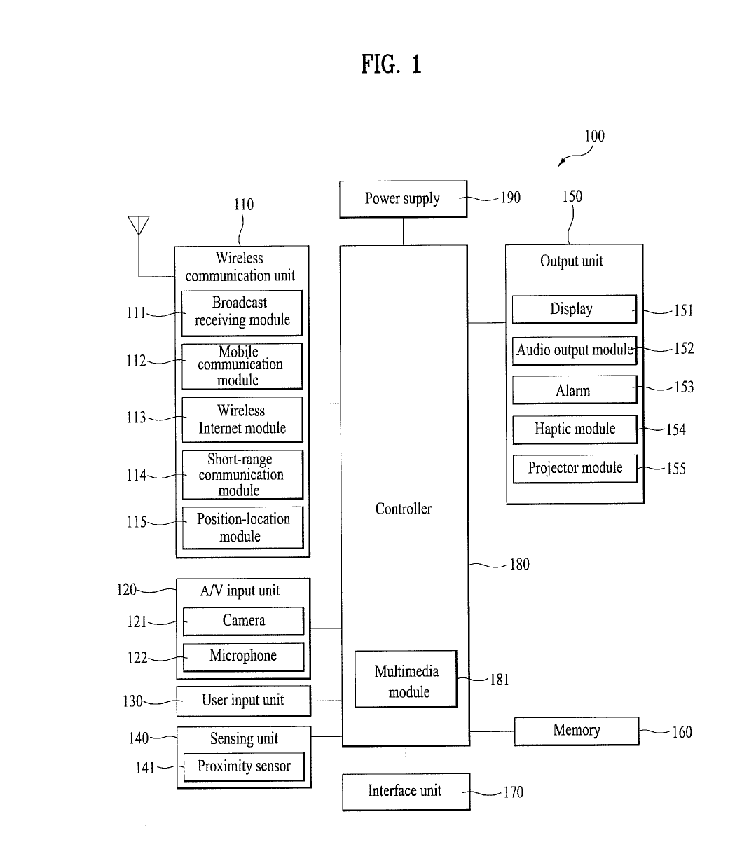

FIG. 1 is a block diagram of a mobile terminal 100 in accordance with an embodiment of the present invention. FIG. 1 shows the mobile terminal 100 according to one embodiment of the present invention includes a wireless communication unit 110, an A/V (audio/video) input unit 120, a user input unit 130, a sensing unit 140, an output unit 150, a memory 160, an interface unit 170, a controller 180, a power supply unit 190 and the like. FIG. 1 shows the mobile terminal 100 having various components, but it is understood that implementing all of the illustrated components is not a requirement. Greater or fewer components may alternatively be implemented.

In the following description, the above elements of the mobile terminal 100 are explained in sequence.

First of all, the wireless communication unit 110 typically includes one or more components which permits wireless communication between the mobile terminal 100 and a wireless communication system or network within which the mobile terminal 100 is located. For instance, the wireless communication unit 110 can include a broadcast receiving module 111, a mobile communication module 112, a wireless internet module 113, a short-range communication module 114, a position-location module 115 and the like.

The broadcast receiving module 111 receives a broadcast signal and/or broadcast associated information from an external broadcast managing server via a broadcast channel.

The broadcast channel may include a satellite channel and a terrestrial channel.

The broadcast managing server generally refers to a server which generates and transmits a broadcast signal and/or broadcast associated information or a server which is provided with a previously generated broadcast signal and/or broadcast associated information and then transmits the provided signal or information to a terminal. The broadcast signal may be implemented as a TV broadcast signal, a radio broadcast signal, and a data broadcast signal, among others. If desired, the broadcast signal may further include a broadcast signal combined with a TV or radio broadcast signal.

At least two broadcast receiving modules 111 can be provided to the mobile terminal 100 in pursuit of simultaneous receptions of at least two broadcast channels or broadcast channel switching facilitation.

The broadcast associated information includes information associated with a broadcast channel, a broadcast program, a broadcast service provider, etc. And, the broadcast associated information can be provided via a mobile communication network. In this case, the broadcast associated information can be received by the mobile communication module 112.

The broadcast associated information can be implemented in various forms. For instance, broadcast associated information may include an electronic program guide (EPG) of digital multimedia broadcasting (DMB) and electronic service guide (ESG) of digital video broadcast-handheld (DVB-H).

The broadcast receiving module 111 may be configured to receive broadcast signals transmitted from various types of broadcast systems. By nonlimiting example, such broadcasting systems include digital multimedia broadcasting-terrestrial (DMB-T), digital multimedia broadcasting-satellite (DMB-S), digital video broadcast-handheld (DVB-H), DVB-CBMS, OMA-BCAST, the data broadcasting system known as media forward link only (MediaFLO®) and integrated services digital broadcast-terrestrial (ISDB-T). Optionally, the broadcast receiving module 111 can be configured suitable for other broadcasting systems as well as the above-explained digital broadcasting systems.

The broadcast signal and/or broadcast associated information received by the broadcast receiving module 111 may be stored in a suitable device, such as a memory 160.

The mobile communication module 112 transmits/receives wireless signals to/from one or more network entities (e.g., base station, external terminal, server, etc.) via a mobile network such as GSM (Global System for Mobile communications), CDMA (Code Division Multiple Access), WCDMA (Wideband CDMA) and so on. Such wireless signals may represent audio, video, and data according to text/multimedia message transceivings, among others.

The wireless internet module 113 supports Internet access for the mobile terminal 100. This module may be internally or externally coupled to the mobile terminal 100. In this case, the wireless Internet technology can include WLAN (Wireless LAN) (Wi-Fi), Wibro (Wireless broadband), Wimax (World Interoperability for Microwave Access), HSDPA (High Speed Downlink Packet Access), GSM, CDMA, WCDMA, LTE (Long Term Evolution) etc.

Wireless internet access by Wibro, HSPDA, GSM, CDMA, WCDMA, LTE or the like is achieved via a mobile communication network. In this aspect, the wireless internet module 113 configured to perform the wireless internet access via the mobile communication network can be understood as a sort of the mobile communication module 112.

The short-range communication module 114 facilitates relatively short-range communications. Suitable technologies for implementing this module include radio frequency identification (RFID), infrared data association (IrDA), ultra-wideband (UWB), as well at the networking technologies commonly referred to as Bluetooth and ZigBee, to name a few.

The position-location module 115 identifies or otherwise obtains the location of the mobile terminal 100. If desired, this module may be implemented with a global positioning system (GPS) module.

According to the current technology, the GPS module 115 is able to precisely calculate current 3-dimensional position information based on at least one of longitude, latitude and altitude and direction (or orientation) by calculating distance information and precise time information from at least three satellites and then applying triangulation to the calculated information. Currently, location and time informations are calculated using three satellites, and errors of the calculated location position and time informations are then amended using another satellite. Besides, the GPS module 115 is able to calculate speed information by continuously calculating a real-time current location.

Referring to FIG. 1, the audio/video (A/V) input unit 120 is configured to provide audio or video signal input to the mobile terminal 100. As shown, the A/V input unit 120 includes a camera 121 and a microphone 122. The camera 121 receives and processes image frames of still pictures or video, which are obtained by an image sensor in a video call mode or a photographing mode. And, the processed image frames can be displayed on the display 151.

The image frames processed by the camera 121 can be stored in the memory 160 or can be externally transmitted via the wireless communication unit 110. Optionally, at least two cameras 121 can be provided to the mobile terminal 100 according to environment of usage.

The microphone 122 receives an external audio signal while the portable device is in a particular mode, such as phone call mode, recording mode and voice recognition. This audio signal is processed and converted into electric audio data. The processed audio data is transformed into a format transmittable to a mobile communication base station via the mobile communication module 112 in case of a call mode. The microphone 122 typically includes assorted noise removing algorithms to remove noise generated in the course of receiving the external audio signal.

The user input unit 130 generates input data responsive to user manipulation of an associated input device or devices. Examples of such devices include a keypad, a dome switch, a touchpad (e.g., static pressure/capacitance), a jog wheel, a jog switch, etc.

The sensing unit 140 provides sensing signals for controlling operations of the mobile terminal 100 using status measurements of various aspects of the mobile terminal. For instance, the sensing unit 140 may detect an open/close status of the mobile terminal 100, relative positioning of components (e.g., a display and keypad) of the mobile terminal 100, a change of position of the mobile terminal 100 or a component of the mobile terminal 100, a presence or absence of user contact with the mobile terminal 100, orientation or acceleration/deceleration of the mobile terminal 100, and free-falling of the mobile terminal 100. As an example, consider the mobile terminal 100 being configured as a slide-type mobile terminal. In this configuration, the sensing unit 140 may sense whether a sliding portion of the mobile terminal is open or closed. Other examples include the sensing unit 140 sensing the presence or absence of power provided by the power supply 190, the presence or absence of a coupling or other connection between the interface unit 170 and an external device. And, the sensing unit 140 can include a proximity sensor 141.

The output unit 150 generates outputs relevant to the senses of sight, hearing, touch and the like. And, the output unit 150 includes the display 151, an audio output module 152, an alarm unit 153, a haptic module 154, a projector module 155 and the like.

The display 151 is typically implemented to visually display (output) information associated with the mobile terminal 100. For instance, if the mobile terminal is operating in a phone call mode, the display will generally provide a user interface (UI) or graphical user interface (GUI) which includes information associated with placing, conducting, and terminating a phone call. As another example, if the mobile terminal 100 is in a video call mode or a photographing mode, the display 151 may additionally or alternatively display images which are associated with these modes, the UI or the GUI.

The display module 151 may be implemented using known display technologies including, for example, a liquid crystal display (LCD), a thin film transistor-liquid crystal display (TFT-LCD), an organic light-emitting diode display (OLED), a flexible display and a three-dimensional display. The mobile terminal 100 may include one or more of such displays.

Some of the above displays can be implemented in a transparent or optical transmittive type, which can be named a transparent display. As a representative example for the transparent display, there is TOLED (transparent OLED) or the like. A rear configuration of the display 151 can be implemented in the optical transmittive type as well. In this configuration, a user is able to see an object in rear of a terminal body via the area occupied by the display 151 of the terminal body.

At least two displays 151 can be provided to the mobile terminal 100 in accordance with the implemented configuration of the mobile terminal 100. For instance, a plurality of displays can be arranged on a single face of the mobile terminal 100 in a manner of being spaced apart from each other or being built in one body. Alternatively, a plurality of displays can be arranged on different faces of the mobile terminal 100.

In case that the display 151 and a sensor for detecting a touch action (hereinafter called ‘touch sensor’) configures a mutual layer structure (hereinafter called ‘touchscreen’), it is able to use the display 151 as an input device as well as an output device. In this case, the touch sensor can be configured as a touch film, a touch sheet, a touchpad or the like.

The touch sensor can be configured to convert a pressure applied to a specific portion of the display 151 or a variation of a capacitance generated from a specific portion of the display 151 to an electric input signal. Moreover, it is able to configure the touch sensor to detect a pressure of a touch as well as a touched position or size.

If a touch input is made to the touch sensor, signal(s) corresponding to the touch is transferred to a touch controller. The touch controller processes the signal(s) and then transfers the processed signal(s) to the controller 180. Therefore, the controller 180 is able to know whether a prescribed portion of the display 151 is touched.

Referring to FIG. 1, a proximity sensor (141) can be provided to an internal area of the mobile terminal 100 enclosed by the touchscreen or around the touchscreen. The proximity sensor is the sensor that detects a presence or non-presence of an object approaching a prescribed detecting surface or an object existing around the proximity sensor using an electromagnetic field strength or infrared ray without mechanical contact. Hence, the proximity sensor has durability longer than that of a contact type sensor and also has utility wider than that of the contact type sensor.

The proximity sensor can include one of a transmittive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor and the like. In case that the touchscreen includes the electrostatic capacity proximity sensor, it is configured to detect the proximity of a pointer using a variation of electric field according to the proximity of the pointer. In this case, the touchscreen (touch sensor) can be classified as the proximity sensor.

The proximity sensor detects a proximity touch and a proximity touch pattern (e.g., a proximity touch distance, a proximity touch duration, a proximity touch position, a proximity touch shift state, etc.). And, information corresponding to the detected proximity touch action and the detected proximity touch pattern can be outputted to the touchscreen.

The audio output module 152 functions in various modes including a call-receiving mode, a call-placing mode, a recording mode, a voice recognition mode, a broadcast reception mode and the like to output audio data which is received from the wireless communication unit 110 or is stored in the memory 160. During operation, the audio output module 152 outputs audio relating to a particular function (e.g., call received, message received, etc.). The audio output module 152 is often implemented using one or more speakers, buzzers, other audio producing devices, and combinations thereof.

The alarm unit 153 is output a signal for announcing the occurrence of a particular event associated with the mobile terminal 100. Typical events include a call received event, a message received event and a touch input received event. The alarm unit 153 is able to output a signal for announcing the event occurrence by way of vibration as well as video or audio signal. The video or audio signal can be outputted via the display 151 or the audio output unit 152. Hence, the display 151 or the audio output module 152 can be regarded as a part of the alarm unit 153.

The haptic module 154 generates various tactile effects that can be sensed by a user. Vibration is a representative one of the tactile effects generated by the haptic module 154. Strength and pattern of the vibration generated by the haptic module 154 are controllable. For instance, different vibrations can be outputted in a manner of being synthesized together or can be outputted in sequence.

The haptic module 154 is able to generate various tactile effects as well as the vibration. For instance, the haptic module 154 generates the effect attributed to the arrangement of pins vertically moving against a contact skin surface, the effect attributed to the injection/suction power of air though an injection/suction hole, the effect attributed to the skim over a skin surface, the effect attributed to the contact with electrode, the effect attributed to the electrostatic force, the effect attributed to the representation of hold/cold sense using an endothermic or exothermic device and the like.

The haptic module 154 can be implemented to enable a user to sense the tactile effect through a muscle sense of finger, arm or the like as well as to transfer the tactile effect through a direct contact. Optionally, at least two haptic modules 154 can be provided to the mobile terminal 100 in accordance with the corresponding configuration type of the mobile terminal 100.

The projector module 155 is the element for performing an image projector function using the mobile terminal 100. And, the projector module 155 is able to display an image, which is identical to or partially different at least from the image displayed on the display unit 151, on an external screen or wall according to a control signal of the controller 180.

In particular, the projector module 155 can include a light source (not shown in the drawing) generating light (e.g., laser) for projecting an image externally, an image producing means (not shown in the drawing) for producing an image to output externally using the light generated from the light source, and a lens (not shown in the drawing) for enlarging to output the image externally in a predetermined focus distance. And, the projector module 155 can further include a device (not shown in the drawing) for adjusting an image projected direction by mechanically moving the lens or the whole module.

The projector module 155 can be classified into a CRT (cathode ray tube) module, an LCD (liquid crystal display) module, a DLP (digital light processing) module or the like according to a device type of a display means. In particular, the DLP module is operated by the mechanism of enabling the light generated from the light source to reflect on a DMD (digital micro-mirror device) chip and can be advantageous for the downsizing of the projector module 151.

Preferably, the projector module 155 can be provided in a length direction of a lateral, front or backside direction of the mobile terminal 100. And, it is understood that the projector module 155 can be provided to any portion of the mobile terminal 100 according to the necessity thereof.

The memory unit 160 is generally used to store various types of data to support the processing, control, and storage requirements of the mobile terminal 100. Examples of such data include program instructions for applications operating on the mobile terminal 100, contact data, phonebook data, messages, audio, still pictures (or photo), moving pictures, etc. And, a recent use history or a cumulative use frequency of each data (e.g., use frequency for each phonebook, each message or each multimedia) can be stored in the memory unit 160. Moreover, data for various patterns of vibration and/or sound outputted in case of a touch input to the touchscreen can be stored in the memory unit 160.

The memory 160 may be implemented using any type or combination of suitable volatile and non-volatile memory or storage devices including hard disk, random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, multimedia card micro type memory, card-type memory (e.g., SD memory, XD memory, etc.), or other similar memory or data storage device. And, the mobile terminal 100 is able to operate in association with a web storage for performing a storage function of the memory 160 on Internet.

The interface unit 170 is often implemented to couple the mobile terminal 100 with external devices. The interface unit 170 receives data from the external devices or is supplied with the power and then transfers the data or power to the respective elements of the mobile terminal 100 or enables data within the mobile terminal 100 to be transferred to the external devices. The interface unit 170 may be configured using a wired/wireless headset port, an external charger port, a wired/wireless data port, a memory card port, a port for coupling to a device having an identity module, audio input/output ports, video input/output ports, an earphone port and/or the like.

The identity module is the chip for storing various kinds of information for authenticating a use authority of the mobile terminal 100 and can include User Identify Module (UIM), Subscriber Identify Module (SIM), Universal Subscriber Identity Module (USIM) and/or the like. A device having the identity module (hereinafter called ‘identity device’) can be manufactured as a smart card. Therefore, the identity device is connectible to the mobile terminal 100 via the corresponding port.

When the mobile terminal 110 is connected to an external cradle, the interface unit 170 becomes a passage for supplying the mobile terminal 100 with a power from the cradle or a passage for delivering various command signals inputted from the cradle by a user to the mobile terminal 100. Each of the various command signals inputted from the cradle or the power can operate as a signal enabling the mobile terminal 100 to recognize that it is correctly loaded in the cradle.

The controller 180 typically controls the overall operations of the mobile terminal 100. For example, the controller 180 performs the control and processing associated with voice calls, data communications, video calls, etc. The controller 180 may include a multimedia module 181 that provides multimedia playback. The multimedia module 181 may be configured as part of the controller 180, or implemented as a separate component.

Moreover, the controller 180 is able to perform a pattern (or image) recognizing process for recognizing a writing input and a picture drawing input carried out on the touchscreen as characters or images, respectively.

The power supply unit 190 provides power required by the various components for the mobile terminal 100. The power may be internal power, external power, or combinations thereof.

Various embodiments described herein may be implemented in a computer-readable medium using, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. Such embodiments may also be implemented by the controller 180.

For a software implementation, the embodiments described herein may be implemented with separate software modules, such as procedures and functions, each of which perform one or more of the functions and operations described herein. The software codes can be implemented with a software application written in any suitable programming language and may be stored in memory such as the memory 160, and executed by a controller or processor, such as the controller 180.

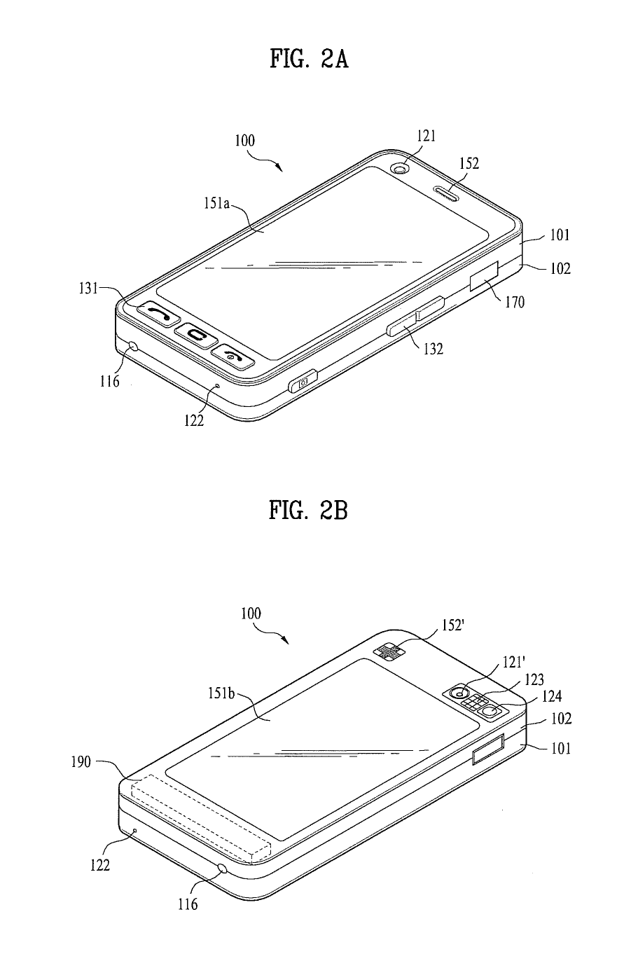

FIG. 2A is a front perspective diagram of a mobile terminal according to one embodiment of the present invention.

The mobile terminal 100 shown in the drawing has a bar type terminal body. Yet, the mobile terminal 100 may be implemented in a variety of different configurations. Examples of such configurations include folder-type, slide-type, rotational-type, swing-type and combinations thereof. For clarity, further disclosure will primarily relate to a bar-type mobile terminal 100. However such teachings apply equally to other types of mobile terminals.

Referring to FIG. 2A, the mobile terminal 100 includes a case (casing, housing, cover, etc.) configuring an exterior thereof. In the present embodiment, the case can be divided into a front case 101 and a rear case 102. Various electric/electronic parts are loaded in a space provided between the front and rear cases 101 and 102. Optionally, at least one middle case can be further provided between the front and rear cases 101 and 102 in addition.

The cases 101 and 102 are formed by injection molding of synthetic resin or can be formed of metal substance such as stainless steel (STS), titanium (Ti) or the like for example.

A display 151, an audio output unit 152, a camera 121, user input units 130/131 and 132, a microphone 122, an interface 180 and the like can be provided to the terminal body, and more particularly, to the front case 101.

The display 151 occupies most of a main face of the front case 101. The audio output unit 151 and the camera 121 are provided to an area adjacent to one of both end portions of the display 151, while the user input unit 131 and the microphone 122 are provided to another area adjacent to the other end portion of the display 151. The user input unit 132 and the interface 170 can be provided to lateral sides of the front and rear cases 101 and 102.

The input unit 130 is manipulated to receive a command for controlling an operation of the terminal 100. And, the input unit 130 is able to include a plurality of manipulating units 131 and 132. The manipulating units 131 and 132 can be named a manipulating portion and may adopt any mechanism of a tactile manner that enables a user to perform a manipulation action by experiencing a tactile feeling.

Content inputted by the first or second manipulating unit 131 or 132 can be diversely set. For instance, such a command as start, end, scroll and the like is inputted to the first manipulating unit 131. And, a command for a volume adjustment of sound outputted from the audio output unit 152, a command for a switching to a touch recognizing mode of the display 151 or the like can be inputted to the second manipulating unit 132.

FIG. 2B is a perspective diagram of a backside of the terminal shown in FIG. 2A.

Referring to FIG. 2B, a camera 121′ can be additionally provided to a backside of the terminal body, and more particularly, to the rear case 102. The camera 121 has a photographing direction that is substantially opposite to that of the former camera 121 shown in FIG. 21A and may have pixels differing from those of the firmer camera 121.

Preferably, for instance, the former camera 121 has low pixels enough to capture and transmit a picture of user's face for a video call, while the latter camera 121′ has high pixels for capturing a general subject for photography without transmitting the captured subject. And, each of the cameras 121 and 121′ can be installed at the terminal body to be rotated or popped up.

A flash 123 and a mirror 124 are additionally provided adjacent to the camera 121′. The flash 123 projects light toward a subject in case of photographing the subject using the camera 121′. In case that a user attempts to take a picture of the user (self-photography) using the camera 121′, the mirror 124 enables the user to view user's face reflected by the mirror 124.

An additional audio output unit 152′ can be provided to the backside of the terminal body. The additional audio output unit 152′ is able to implement a stereo function together with the former audio output unit 152 shown in FIG. 2A and may be used for implementation of a speakerphone mode in talking over the terminal.

A broadcast signal receiving antenna 124 can be additionally provided to the lateral side of the terminal body as well as an antenna for communication or the like. The antenna 124 constructing a portion of the broadcast receiving module 111 shown in FIG. 1 can be retractably provided to the terminal body.

A power supply unit 190 for supplying a power to the terminal 100 is provided to the terminal body. And, the power supply unit 190 can be configured to be built within the terminal body. Alternatively, the power supply unit 190 can be configured to be detachably connected to the terminal body.

A touchpad 135 for detecting a touch can be additionally provided to the rear case 102. The touchpad 135 can be configured in a light transmittive type like the display 151. In this case, if the display 151 is configured to output visual information from its both faces, it is able to recognize the visual information via the touchpad 135 as well. The information outputted from both of the faces can be entirely controlled by the touchpad 135. Alternatively, a display is further provided to the touchpad 135 so that a touchscreen can be provided to the rear case 102 as well.

The touchpad 135 is activated by interconnecting with the display 151 of the front case 101. The touchpad 135 can be provided in rear of the display 151 in parallel. The touchpad 135 can have a size equal to or smaller than that of the display 151.

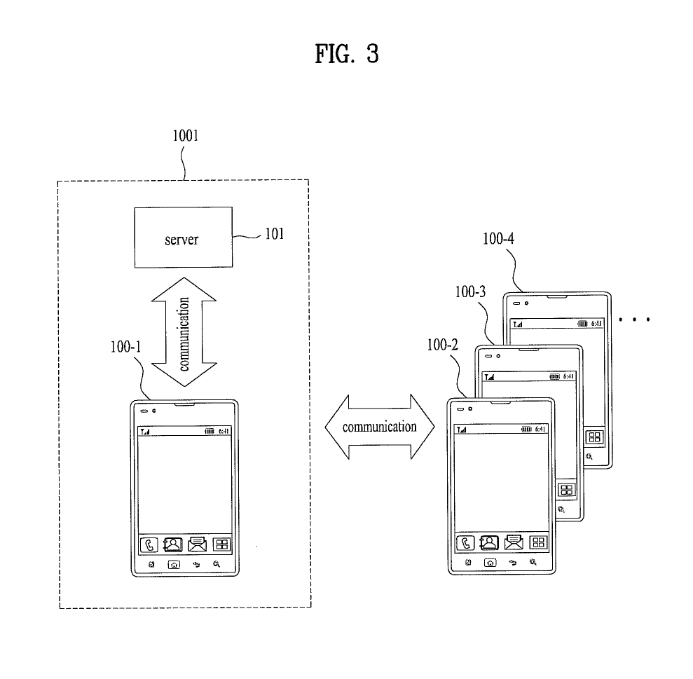

FIG. 3 is a schematic diagram of a system capable of holding a virtual conference according to an embodiment of the present invention.

Referring to FIG. 3, a virtual conference system according to one embodiment of the present invention can be mainly divided into a host terminal 100-1 hosting a virtual conference and a plurality of mobile terminals 100-2 to 100-n participating in the virtual conference. The host terminal 100-1 may include a terminal having functions different from those of other mobile terminals or may simply include the mobile terminal 100 of a user intending to host the virtual conference. Hence, in the following description of embodiments of the present invention, assume that a host terminal and a participating mobile terminal do not actually differ from each other in functional configuration but differ from each other in a subject who uses the corresponding terminal.

The host terminal 100-1 is connected to a server 101 and is then able to transmit a participation request signal to each of the mobile terminals 100-2, 100-3 and 100-4 intending to participate. In the following description, such a mobile terminal intending to participate shall be named a participating terminal.

Meanwhile, according to embodiments of the present invention, the host terminal 100-1 can host a virtual conference by being connected to the server. Moreover, the host terminal 100-1 itself can play a role as a server. Hence, in the following description of the present invention, an integrated unit 1001 including the server 101 and the host terminal 100-1 shall be just named the host terminal 100-1.

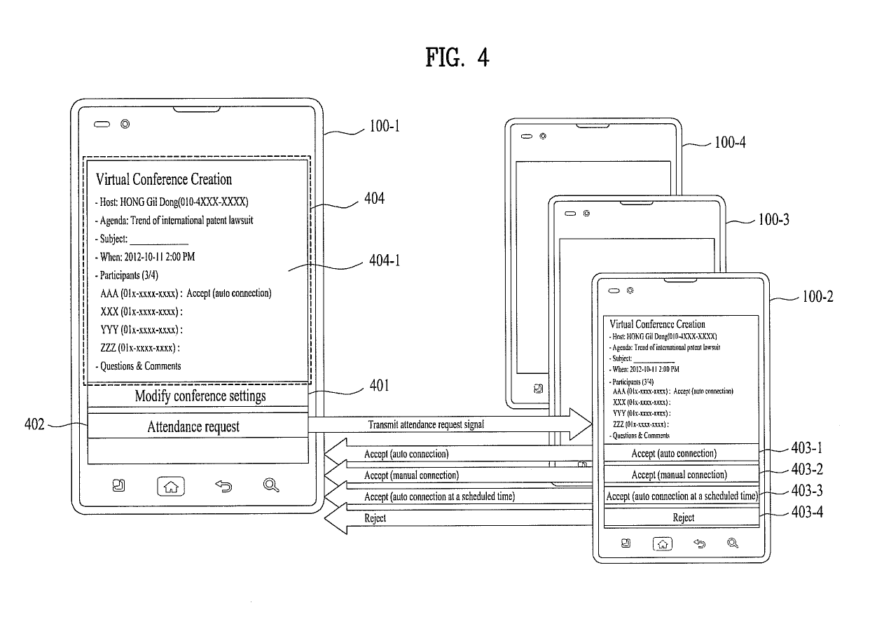

FIG. 4 is a diagram for one example of transmitting an attendance request signal to a participating terminal from a host terminal according to one embodiment of the present invention.

Referring to FIG. 4, a host terminal 100-1 according to one embodiment of the present invention is outputting a setting item 404 to create a virtual conference. Particularly, the setting item 404 may include information on at least one of a host, a matter, a time and date, participants and the like.

After sub-items included in the conference setting item 404 have been set up by a user intending to host the conference, the host terminal 100-1 can receive an input of a request for transmitting an attendance request signal to each of participating terminals 100-2, 100-3, 100-4 and the like. In response to the request, the controller 180 can transmit the attendance request signal to each of the participating terminals 100-2, 100-3, 100-4 and the like based on the completed setting item 404.

For instance, after the settings have been completed by user's inputs, if the host terminal 100-1 receives an input of transmitting the attendance request signal, the host terminal 100-1 can transmit the attendance request signal to each of the participating terminals 100-2, 100-3, 100-4 and the like in response to the received input.

In doing so, the setting item 404, which has been completed before the corresponding transmission, can be included in the attendance request signal entirely or in part. For instance, the attendance request signal may include the information on a start date and time of the conference.

Having received the attendance request signal for the prescribed conference, each of the participating terminals 100-2, 100-3, 100-4 and the like can output the setting item 404, which is the information included in the attendance request signal, to the display unit 151 in order to inform the user of the information on the corresponding conference. This is to enable users of the participating terminals 100-2, 100-3, 100-4 and the like to determine whether to attend at the conference by referring to the setting item 404.

Hence, each of the participating terminals 100-2, 100-3, 100-4 and the like receives an input for whether to attend at the conference from the corresponding user in response to the attendance request signal. For instance, each of the participating terminals 100-2, 100-3, 100-4 and the like outputs a plurality of objects 403 regarding whether to attend. If receiving an input of selecting each of the objects 403, each of the participating terminals 100-2, 100-3, 100-4 and the like can determine whether to accept the attendance.

For instance, referring to FIG. 4, the objects 403 regarding whether to attend can be represented as 4 items including ‘accept (auto connection)’, ‘accept (manual connection)’, ‘accept (auto connection at a scheduled time)’ and ‘reject’.

The object ‘accept (auto connection)’ 403-1 is an operation of accepting an attendance and accessing a conference at a conference start time automatically in response to the attendance request signal. Hence, if the object ‘accept (auto connection)’ 403-1 is selected in response to the attendance request signal, the controller 180 of each of the participating terminals 100-2, 100-3, 100-4 and the like automatically accesses the corresponding virtual conference at the conference start time.

The object ‘accept (manual connection)’ 403-2 is an operation of accepting an attendance and accessing a conference at a conference start time manually in response to the attendance request signal. Hence, if the object ‘accept (manual connection)’ 403-2 is selected in response to the attendance request signal, the controller 180 of each of the participating terminals 100-2, 100-3, 100-4 and the like can output a confirmation window for querying whether to access the conference to a corresponding user on the conference start time. If the corresponding user makes a request for accessing the conference in response to the outputted confirmation window, the corresponding one of the participating terminals 100-2, 100-3, 100-4 and the like accesses the conference in response to the request.

The object ‘accept (auto connection at a scheduled time)’ 403-3 is an operation of accepting attendance and accessing a conference not at a conference start time but at a user-set time automatically in response to the attendance request signal. For instance, assuming that a start time of the corresponding conference is 14:00, when the object ‘accept (auto connection at a scheduled time)’ 403-3 is selected, if a user sets to access the conference at 14:15, the controller 180 of a corresponding one of the participating terminals 100-2, 100-3, 100-4 and the like automatically accesses the conference at 14:15.

The object ‘reject’ 403-4 is an option of rejecting an attendance.

Meanwhile, if receiving the input regarding whether to attend in response to the attendance request signal from each of the participating terminals 100-2, 100-3, 100-4 and the like, the host terminal 100-1 can control the input to be reflected by the setting item 404 currently outputting the received information indicating whether to attend [404-1]. In the example shown in FIG. 4, if the host terminal 100-1 receives the attendance information called ‘accept (auto connection)’ from a participant named AAA on a participant list, the host terminal 100-1 can display the received attendance information indicating ‘accept (auto connection)’ on the setting item 404 in response to the reception [404-1].

Meanwhile, the user of the host terminal 100-1 may attempt to modify the conference setting item 404, which was previously set before transmitting the attendance request signal, after transmitting the attendance request signal.

If receiving an input of a request for modifying the setting item 404, the host terminal 100-1 modifies the setting item 404 and is then able to transmit the modified setting item 404 to the participating terminals 100-2, 100-3, 100-4 and the like, in response to the received input.

For instance, after the setting item 404 has been modified, the host terminal 100-1 can transmit the modified setting item 404 to the participating terminals 100-2, 100-3, 100-4 and the like in response to an input of selecting a conference setting modifying object 401.

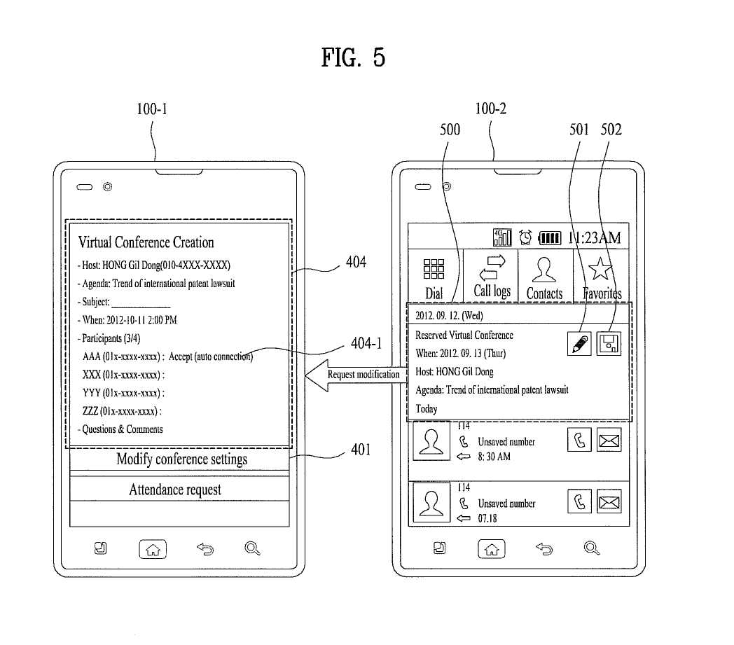

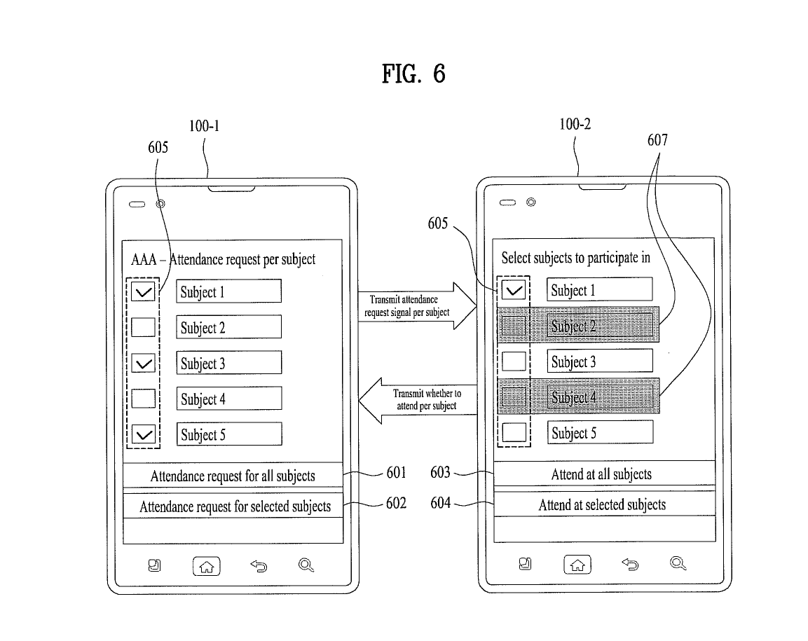

Meanwhile, the user of each of the participating terminals 100-2, 100-3, 100-4 and the like may attempt to change the attendance information determined for the conference attendance request or may request a change of the contents of the conference setting item 404 itself. Hence, a method for each of the participating terminals 100-2, 100-3, 100-4 and the like to request a change of the setting item 404 according to an embodiment of the present invention is described with reference to FIG. 5 as follows.

FIG. 5 is a diagram for one example of a method of making a request for changing a setting item of a conference according to one embodiment of the present invention.

Referring to FIG. 5, assume that the participating terminal 100-2 accepts the attendance request in response to the attendance request signal received from the host terminal 100-1 and then selects the option of auto connection at the conference start time. Hence, it can be observed from the host terminal 100-1 shown in FIG. 5 that the attendance information, which indicates an attendance or non-attendance of the participating terminal (e.g., the participant AAA shown in FIG. 5) 100-2, is represented as ‘accept (auto connection)’ 404-1.

In this case, the controller 180 of the participating terminal 100-2 can output an information 500 on a reserved virtual conference.

Meanwhile, the user of the participating terminal 100-2 may intend to change the attendance information, which indicates whether to attend at the reserved virtual conference, due to a situation of the user. For instance, in the example shown in FIG. 5, the user of the participating terminal 100-2 may intend to change a current option into an option of rejecting the attendance at the conference.

If receiving an input of a request to change the attendance information indicating whether to attend at the reserved virtual conference, the participating terminal 100-2 according to one embodiment of the present invention can a changed attendance information to the host terminal 100-1 in response to the inputted request. For instance, if receiving an input of selecting a change object 501 for changing the attendance information, the participating terminal 100-2 can transmit the changed attendance information to the host terminal 100-1 in response to the received input.

Moreover, the participating terminal 100-2 according to one embodiment of the present invention can make a request for changing the setting item 404 to the host terminal 100-1. For instance, if a case corresponding to the preset setting item 404 is ‘Trend of international patent lawsuit’, when the participating terminal 100-2 receives an input of selecting the change object 501 together with an input of changing ‘Trend of international patent lawsuit’ into ‘Trend of international patent lawsuit and Direction to proceed’, the participating terminal 100-2 can transmit this change request to the host terminal 100-1.

Meanwhile, a virtual conference system according to one embodiment of the present invention can transmit an attendance request signal per detailed subject or determine whether to attend per detailed subject in response to the attendance request signal. This is described in detail with reference to FIG. 6 as follows.

FIG. 6 is a diagram for one example of a method of requesting an attendance per detailed subject or determining whether to attend per detailed subject according to one embodiment of the present invention.

Referring to FIG. 6, assume that a virtual conference includes 5 subjects Subject 1 to Subject 5. If the subjects, in which a participant ‘AAA’ participates in, include Subject 1, Subject 3 and Subject 5, a user of a host terminal 100-1 can make a request for attending at the virtual conference by selecting the participating subjects only to the participant ‘AAA’.

For instance, the host terminal 100-1 shown in FIG. 6 can provide a user with a check box 605 for making a selection of each subject. If an object 602 of requesting to attend at the selected subject is selected, the host terminal 100-1 can transmit an attendance request signal for the subject, of which check box is checked, to a participating terminal 100-2. If an object 601 of requesting to attend at all subjects irrespective of making a selection is selected, the host terminal 100-1 can transmit an attendance request signal for all subjects to the participating terminal 100-2.

The participating terminal 100-2 shown in FIG. 6 displays a state diagram in case of receiving an attendance request signal for Subject 1, Subject 3 and Subject 5. According to one embodiment of the present invention, an attendance non-requested subject can be outputted in a manner of being discriminated from an attendance requested subject. For instance, the attendance non-requested subject can be outputted together with an indicator 607 indicating the corresponding state.

In the example shown in FIG. 6, the user of the participating terminal 100-2 selects a subject to attend at from a plurality of attendance requested subjects and then controls the participating terminal 100-2 to transmit an information indicating that the participating terminal 100-2 will attend at the selected subject to the host terminal 100-1.

For instance, the controller 180 of the participating terminal 100-2 can provide a check box 605 for selecting each of a plurality of the attendance requested subjects. In response to an input of selecting an object 604 of transmitting an attendance information indicating whether to attend at the selected subject, the participating terminal 100-2 can transmit an information indicating the participating terminal 100-2 will attend at the checked subject to the host terminal 100-1. Meanwhile, in response to an object of transmitting an information indicating whether to attend irrespective of check or uncheck, the participating terminal 100-2 can transmit an information indicating that the participating terminal 100-2 will attend at all selectable subjects to the host terminal 100-1.

In the virtual conference system according to one embodiment of the present invention, after a participation in a prescribed subject has been requested and accepted by the selections shown in FIG. 6, if a conference progress level reaches the selected subject, the host terminal 100-1 can send a message instructing the participating terminal 100-2 to attend at the conference to the participating terminal 100-2. Since the participating terminal 100-2 may not pay attention to the conference on the subject in which the participating terminal 100-2 does not participate, the message is attempted to inform the participating terminal 100-2 of the subject in which the participating terminal 100-2 intends to participate.

Meanwhile, if virtual conference materials exist in a virtual conference system according to an embodiment of the present invention, a host terminal 100-1 may share the virtual conference materials with other participating terminals 100-2, 100-3, 100-4 and the like.

While the virtual conference materials are saved in the memory 160 of the host terminal 100-1, the host terminal 100-1 can perform upload and download to share the virtual conference materials with the participating terminals 100-2, 100-3, 100-4 and the like.

Moreover, in case that the host terminal 100-1 and the server 101 are configured separately [cf. FIG. 3], the virtual conference materials can be shared in a following manner. First of all, the host terminal 100-1 enables the virtual conference materials to be saved in the server 101 by uploading the virtual conference materials to the server 101. Secondly, each of the participating terminals 100-2, 100-3, 100-4 and the like downloads the saved virtual conference materials.

Meanwhile, when each of the participating terminals 100-2, 100-3, 100-4 and the like downloads the virtual conference materials from the host terminal 100-1, the corresponding participating terminal can perform upload and download for the virtual conference materials in advance of a conference time in response to the transmission and reception of an attendance request signal for the virtual conference. This is to download the virtual conference materials in advance of the conference time in case that an amount of the virtual conference materials is large. Moreover, in case that a plurality of users participate in the conference, if a plurality of the users simultaneously access the server at the conference start time, it may cause a considerable load. Hence, the virtual conference materials are downloaded in advance of the conference start time.

Each of the participating terminals 100-2, 100-3, 100-4 and the like can save the downloaded virtual conference materials in the memory 160 of its own.

In the virtual conference system according to the embodiment of the present invention, if the virtual conference materials exist for each of a plurality of subjects, the upload and download are performed on the virtual conference materials corresponding to the subject intended to participate in only. For example corresponding to FIG. 6, when the host terminal 100-1 transmits an attendance request signal for Subject 1, Subject 3 and Subject 5 to the participating terminal 100-2, the host terminal 100-1 can transmit the virtual conference materials on Subject 1, Subject 3 and Subject 5 to the participating terminal 100-2.

According to another embodiment of the present invention, when virtual conference materials exist, if there is an accept signal in response to an attendance request signal for a virtual conference, a virtual conference system performs upload and download in response to the accept signal.

According to a further embodiment of the present invention, when virtual conference materials exist, if a data size for the virtual conference materials is further included in an attendance request signal for a virtual conference, the participating terminal 100-2 can determine a download initiating timing point of downloading the virtual conference materials in consideration of the data size and/or a current data transmitted/received speed or rate.

In a virtual conference system according to an embodiment of the present invention, once a conference begins, a host terminal and a participating terminal can deliver a voice of a user of one of the terminals to a user of the other using the microphones 122 and the audio output units 152. In particular, once the conference begins, the host terminal receives a user's voice using the microphone 122 and is then able to transmit the received voice to the participating terminal. Subsequently, the participating terminal can output the voice received from the host terminal to the audio output unit 152. Moreover, a voice of the user of the participating terminal can be transmitted to the host terminal to the contrary.

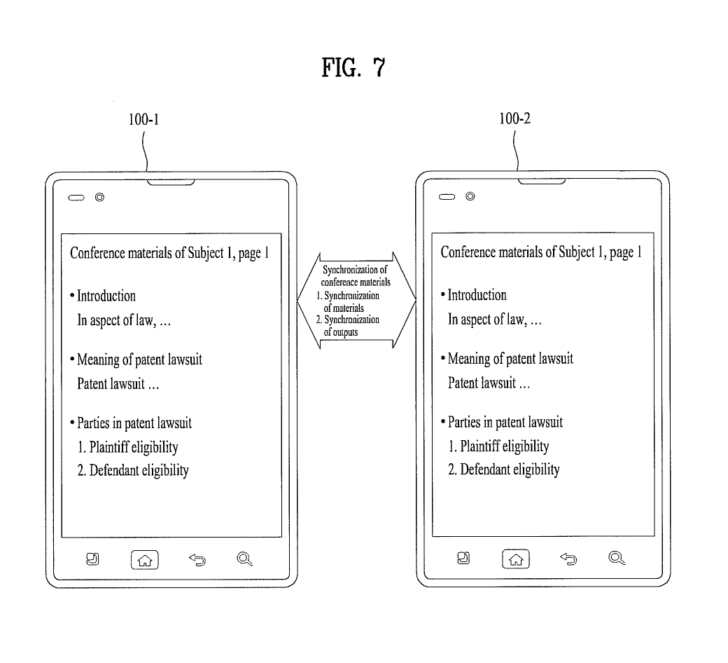

In a virtual conference system according to an embodiment of the present invention, if a conference begins, each of a host terminal and a participating terminal outputs virtual conference materials. A detailed method of outputting the virtual conference materials from each of the host terminal and the participating terminal is described in detail with reference to FIG. 7 as follows.

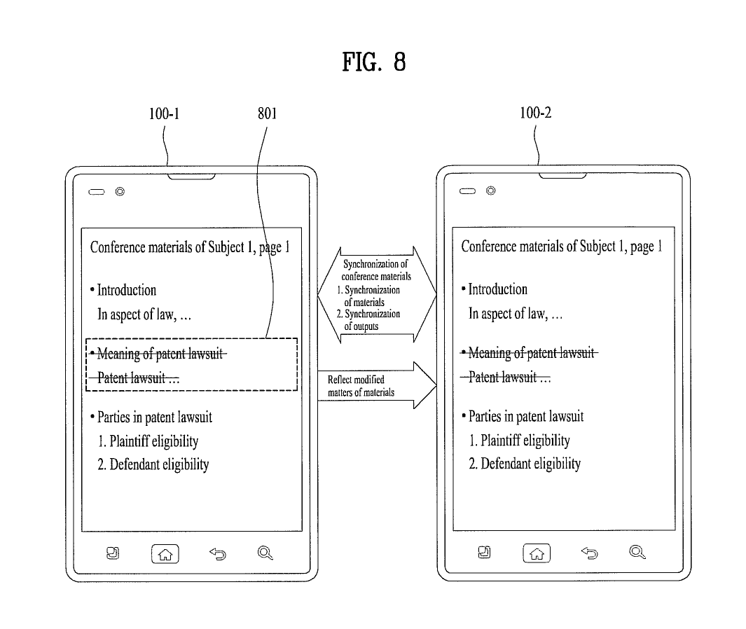

FIG. 7 and FIG. 8 are diagrams for examples of synchronizing virtual conference materials between a host terminal and a participating terminal in a virtual conference system according to one embodiment of the present invention.

In FIG. 7 and FIG. 8, assume that the controller 180 of each of a host terminal 100-1 and a participating terminal 100-2 is outputting conference materials on Subject 1 that is a 1^{st} subject in virtual conference materials. Particularly, the virtual conference materials include document materials for example, by which the virtual conference materials may be non-limited.

In case that the virtual conference materials are currently outputted by the host terminal 100-1, the host terminal 100-1 transmits synchronization information to participating terminals 100-2, 100-3, 100-4 and the like. In this case, the synchronization information is the information for matching an output of the virtual conference materials. In case of the virtual conference materials per subject, the synchronization information may include an information indicating what is the corresponding subject and/or a page information.

According to one embodiment of the present invention, synchronization of virtual conference materials may include synchronization of materials and synchronization of outputs.

First of all, in case that virtual conference materials are modified, the synchronization of materials means that a modified item is reflected. The synchronization of materials is described in detail with reference to FIG. 8 as follows.

Referring to FIG. 8, if a user of a host terminal 100-1 requests a modification of virtual conference materials, the host terminal 100-1 modifies the virtual conference materials and also transmits a synchronization information reflecting a modified content to a participating terminal 100-2. In the example shown in FIG. 8, assume a case that the modification is performed in a manner that the user of the host terminal 100-1 deletes a portion 801 of the virtual conference materials.

If the host terminal 100-1 transmits a synchronization information including a modified item of deleting the portion 801 of the virtual conference materials to the participating terminal 100-2, the participating terminal 100-2 can control the modified item to be reflected by the virtual conference materials with reference to the synchronization information. In particular, the participating terminal 100-2 can perform the modification of deleting the portion 801 of the virtual conference materials likewise.

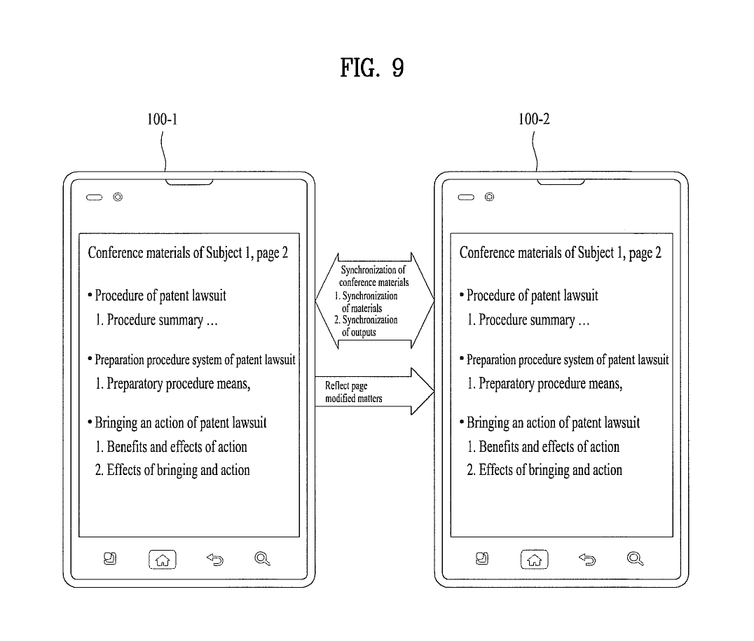

Secondly, the synchronization according to one embodiment of the present invention may include synchronization of outputs. In particular, the synchronization of outputs may mean that a virtual conference materials outputted page is identically outputted. The synchronization of outputs shall be described in detail with reference to FIG. 9 as follows.

FIG. 9 shows one example of a state that a next page (page 2) turned by a user from a previous page of virtual conference materials is displayed on a host terminal 100-1.

Referring to FIG. 9, if receiving an input of a signal for requesting to turn a page from a user, the host terminal 100-1 generates a synchronization signal including page information in response to the received input and then transmits the generated synchronization system to the participating terminal 100-2.

Having received the synchronization signal, the participating terminal 100-2 can determine an output page of the currently outputted virtual conference materials based on the received synchronization signal.

Meanwhile, according to an embodiment mentioned in the following description, while the virtual conference materials are outputted on the display unit 151 of the participating terminal 100-2, a memo can be recorded in a manner of overlaying the virtual conference materials. In case that a page is automatically turned in the course of recording the memo, it may cause inconvenience to a user who is using it.

Therefore, according to one embodiment of the present invention, while a user of a participating terminal 100-2 inputs a memo, although a synchronization signal including a page information is received, the participating terminal 100-2 controls a page not to be automatically turned. Thereafter, if the input of the memo is completed, the participating terminal 100-2 can control the page to be automatically turned at the timing point of completing the input of the memo or after a prescribed time from the completed timing point.

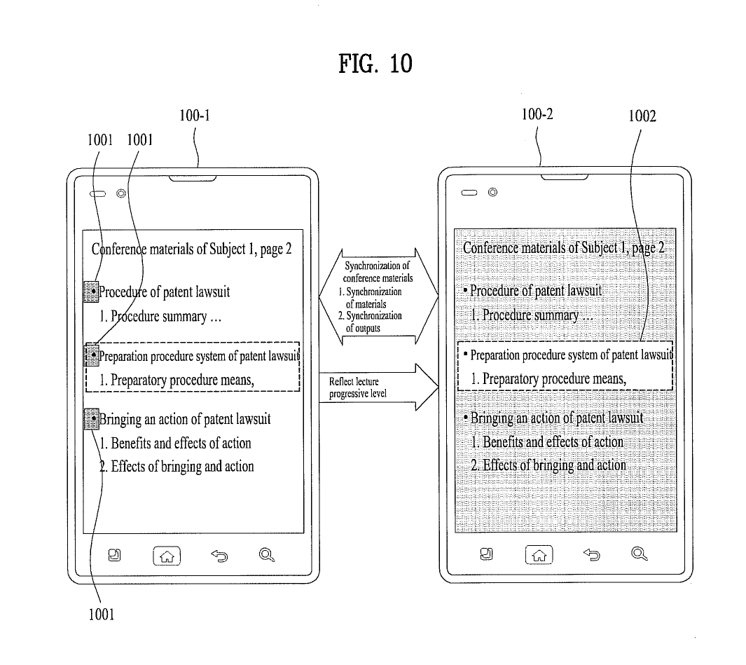

Moreover, the synchronization of outputs in a virtual conference system according to one embodiment of the present invention may include an operation of outputting an indicator indicating a lecture progress level. This indicator is described in detail with reference to FIG. 10 as follows.

FIG. 10 is a diagram for one example of a method of synchronizing an output of an indicator indicating a lecture progress level according to one embodiment of the present invention.

Referring to FIG. 10, assume that virtual conference materials of a host terminal 100-1 and a participating terminal 100-2 are synchronized with each other and that a same page is being outputted. If the host terminal 100-1 recognizes a region in which a lecture is in progress by a user, the host terminal 100-1 can control an information for identifying the corresponding region to be included in a synchronization information. The host terminal 100-1 is able to transmit the synchronization information including the information for identifying the corresponding region to the participating terminal 100-2.

In outputting lecture materials, the participating terminal 100-2 having received the synchronization information including the region identifying information can control the corresponding region to be outputted in a manner of being identifiable from other regions. For instance, referring to FIG. 10, the participating terminal 100-2 can output an indicator 1002 indicating the identified region together with the virtual conference materials.

Meanwhile, for example of a method for the host terminal 100-1 to recognize the region in which the lecture is in progress by the user, the host terminal 100-1 can output a plurality of progress identifying object 1001 for identifying progress positions of a lecture. In particular, a plurality of the progress identifying objects 1001 can be appropriately arranged in progressive order of the lecture. If the progress identifying object 1001 is selected by a user, the host terminal 100-1 can determine that the corresponding region is a lecture progressive region in response to the selection.

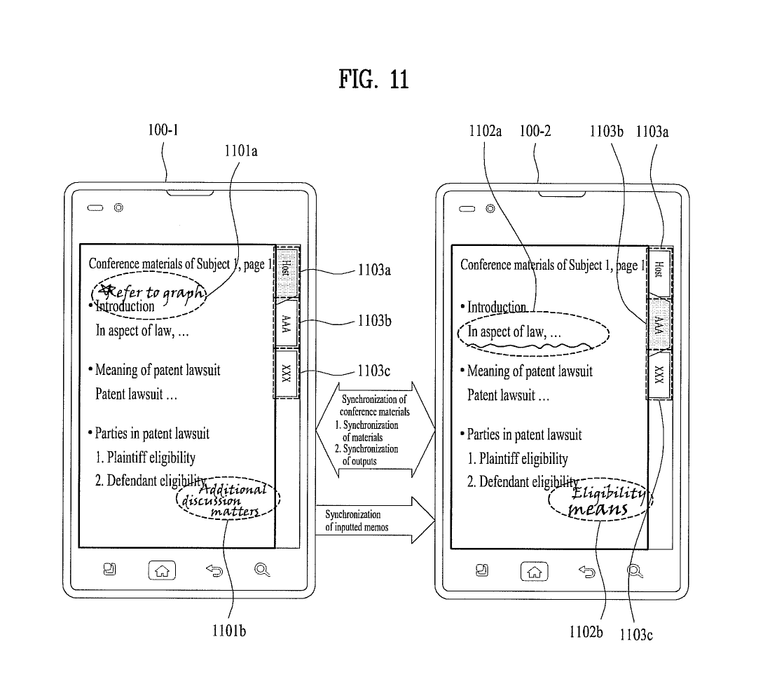

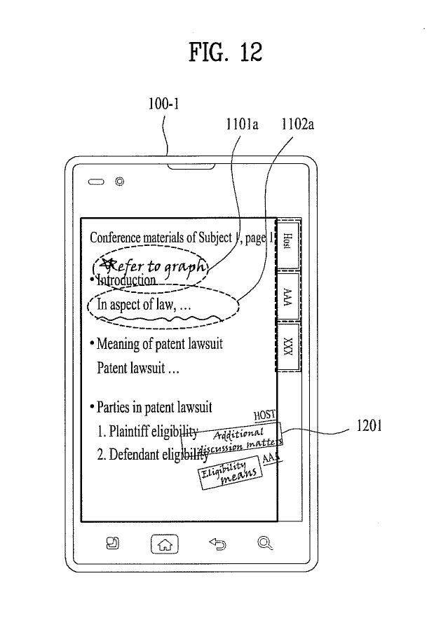

Furthermore, the synchronization of outputs in a virtual conference system according to one embodiment of the present invention may include synchronization of memos inputted by users of participating terminals 100-2, 100-3, 100-4 and the like. In the following description, one example of a method of inputting and synchronizing memos in a virtual conference system according to the present invention is described with reference to FIG. 11 and FIG. 12.

FIG. 11 is a diagram for one example of inputting memos to a host terminal and a participating terminal according to one embodiment of the present invention. According to one embodiment of the present invention, each of the host terminal and the participating terminal outputs virtual conference materials and also outputs a memo layer overlaying the virtual conference materials. In doing so, since the memo layer overlays the virtual conference materials, the corresponding memo layer may be transparent.

A user of each of the host terminal and the participating terminal can input a memo 1101 to the memo layer. For instance, memos 1101 and 1102 can be handwritten by users of the host terminal and the participating terminal on the touchscreens 151 provided to the host terminal and the participating terminal, respectively.

In the example shown in FIG. 11, the host terminal 100-1 outputs the memo 1101 inputted by the user together with the virtual conference materials. And, the participating terminal 100-2 outputs the memo 1102 inputted by the user together with the virtual conference materials.

Moreover, in the virtual conference system according to one embodiment of the present invention, the memo layer can separately be displayed and/or saved for each terminal. Each of the host and participating terminals shown in FIG. 11 can output a category 1103 for managing the corresponding memo layer for each of the terminals as well.

The memo 1101 inputted via the host terminal 100-1 can be inputted to a memo layer corresponding to a host category 1103a, while the memo 1102 inputted via the participating terminal 100-2 can be inputted to a memo layer corresponding to a category ‘AAA’ 1103. In this case, ‘AAA’ indicates a user of the participating terminal 100-2.

The participating terminal 100-2 can read the memo inputted via the host terminal 100-1 using the host category 1103. If receiving a request for outputting the memo layer inputted to the host terminal 100-1 from the user, the participating terminal 100-2 can output the memo layer inputted to the host terminal 100-1. For instance, if receiving an input of selecting the ‘host’ category 1103a, the participating terminal 100-2 can output the memo layer inputted to the host terminal 10-1.

Meanwhile, according to one embodiment of the present invention, a plurality of memo layers can be outputted in a manner of overlaying each other. In the example shown in FIG. 11, the layer corresponding to the category ‘host’ 1103a and the layer corresponding to the category ‘AAA’ 1103b can be outputted in a manner of overlaying each other. This embodiment is described in detail with reference to FIG. 12 as follows.

FIG. 12 is a diagram for one example of a method of displaying an overlaid memo layer according to one embodiment of the present invention.

Referring to FIG. 12, a host terminal 100-1 displays a memo layer corresponding to a category ‘host’ 1103a and a memo layer corresponding to a category ‘AAA’ 1103b in a manner that the memo layers overlay each other. In particular, a memo inputted to the memo layer corresponding to the category ‘host’ 1103a and a memo inputted to the memo layer corresponding to the category ‘AAA’ 1103b are outputted together.

Meanwhile, in case that a plurality of memo layers are outputted together, it may happen that memos respectively inputted to the memo layers overlay each other. Such an example is illustrated in FIG. 11 that shows a case that the memo 1101b and the memo 1102b overlay each other.

Thus, when a plurality of the memo layers are outputted in a manner of overlaying each other, if the memos respectively inputted to the memo layers overlay each other, the mobile terminal 100 can rearrange locations of the memos 1101 and 1102 respectively inputted to the memo layers.

Referring to FIG. 12, since ‘additional discussion matter’ corresponding to a memo of a memo layer ‘host’, overlays ‘Eligibility means’ corresponding to a memo of a memo layer ‘AAA’, it can be observed that a location of the memo of ‘additional discussion matter’ is rearranged in top direction by a prescribed distance.

Meanwhile, when a plurality of the memo layers are outputted together, an indicator indicating that the outputted memo 1101/1102 corresponds to the memo inputted to which memo layer can be outputted as well. For instance, when the host terminal 100-1 outputs the memos 1101 and 1102, an origin of the memo layer is outputted together with the corresponding memo in order to indicate that the memo 1101/1102 is inputted to which memo layer.

Meanwhile, in a virtual conference system according to an embodiment of the present invention, a host and a participant can share audio/video data recorded via terminals of the host and the participant with each other as well as conference materials. For instance, in case of attempting to obtain a consent or confirmation for an important item from the host/participant, a voice ‘consent to the issue’ or ‘not consent to the issue’ of the host/participant is recorded though a terminal of the host/participant and the recorded data can be shared together with the conference materials.

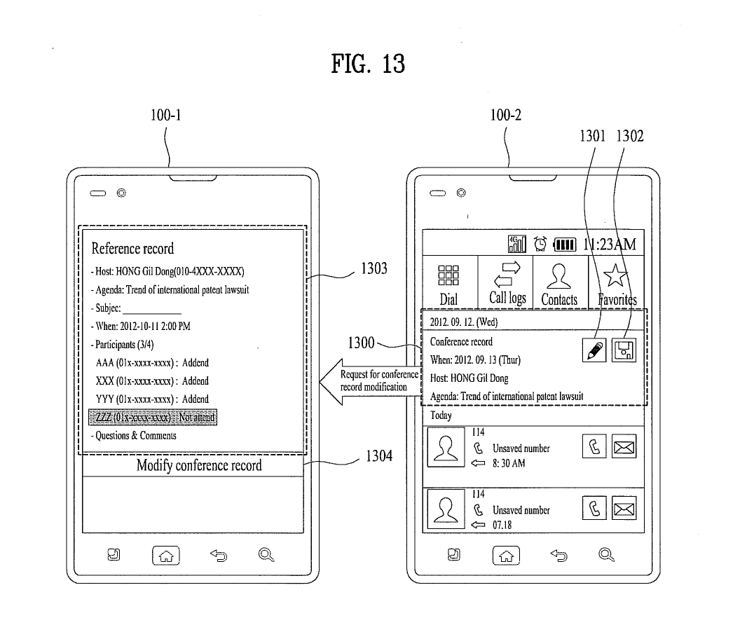

In a virtual conference system according to an embodiment of the present invention, in case that a virtual conference is closed, a control method of saving and reading conference records of the closed virtual conference is provided. An embodiment for this method is described with reference to FIG. 13 as follows.

FIG. 13 is a diagram for one example of a controlling method after closing a conference in a virtual conference system according to one embodiment of the present invention. Assume that a virtual conference was held on Thursday, Sep. 13, 2012 and that a current date is Friday, Sep. 14, 2012.

Referring to FIG. 13, a participating terminal 100-2 outputs a record reading object 1300 corresponding to a closed remote virtual conference to the display unit 151. According to one embodiment of the present invention, if receiving a request for outputting a conference record of a closed remote virtual conference, the mobile terminal 100 outputs the conference record in response to the request. In this case, the conference record may include at least one of an issue, agenda, host, participant list, date, conference time and the saved virtual conference materials of the closed remote virtual conference. For instance, if receiving an input of selecting the record reading object 1300, the mobile terminal 100 outputs the conference record in response to the received input.

Meanwhile, according to one embodiment of the present invention, a host terminal 100-1 is able to modify the conference record for the closed virtual conference. For instance, if an input for modifying a content of the conference record and a conference record modifying object 1304 are selected, the host terminal 100-1 can modify the conference record for the virtual conference in response to the selection.

Moreover, according to one embodiment of the present invention, a participating terminal 100-2 is able to make a request for modifying the conference record for the closed virtual conference to the host terminal 100-1. For instance, if an input for modifying a content of the conference record and a modification request object 1301 are selected, the participating terminal 100-2 can transmit a signal for requesting to modify the conference record to the host terminal 100-1 in response to the selection.

Furthermore, according to one embodiment of the present invention, the mobile terminal 100 can upload materials in addition to virtual conference materials included in the conference record. For instance, if a materials upload object 1302 is selected, the participating terminal 100-2 can upload materials in addition to the virtual conference materials included in the conference record in response to the selection. The additionally uploaded materials can be set to be shared by the host terminal and/or the participating terminals having attended at the closed conference. And, a message indicating that the materials have been additionally uploaded can be sent. In particular, this message can be sent to the participating terminals 100-2, 100-3, 100-4 and the like by the host terminal 100-1 or the server 101 shown in FIG. 3.

Meanwhile, although there is a terminal scheduled to attend at a conference after a conference start time, if the conference is closed before the participation of the corresponding terminal, it is necessary to inform the participation scheduled terminal that the conference has been closed. Therefore, according to an embodiment of the present invention, although there is a terminal scheduled to attend at a conference after a conference start time, if the conference is closed before the participation of the corresponding terminal, it is able to automatically send a message indicating that the conference has been closed to the participation scheduled terminal. In doing so, the message can be sent to the participating terminals 100-2, 100-3, 100-4 and the like by the host terminal 100-1 or the server 101 shown in FIG. 3.

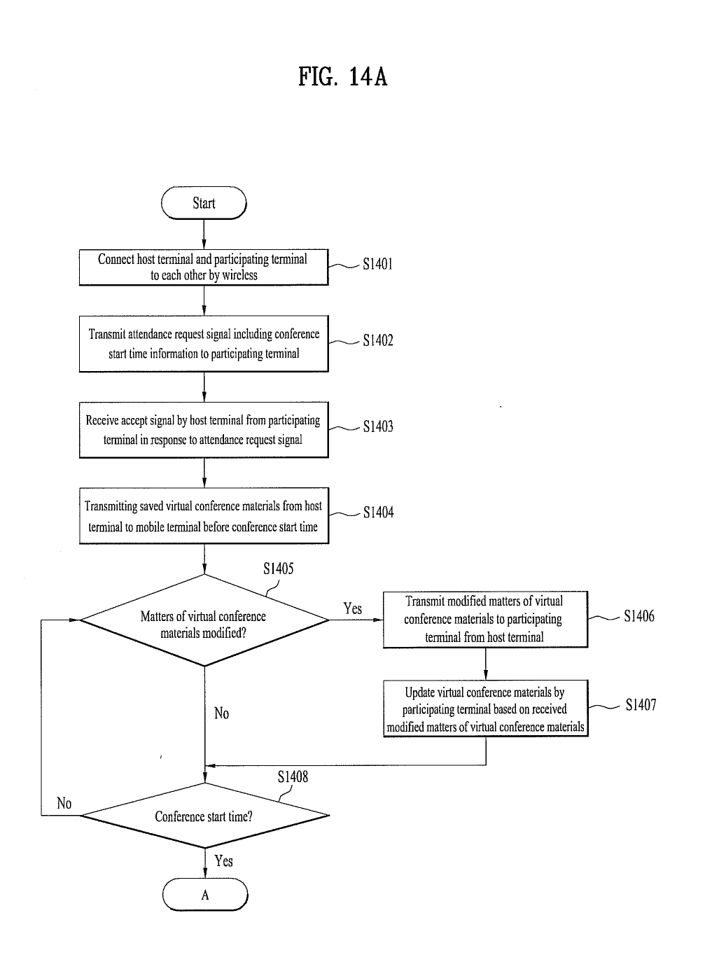

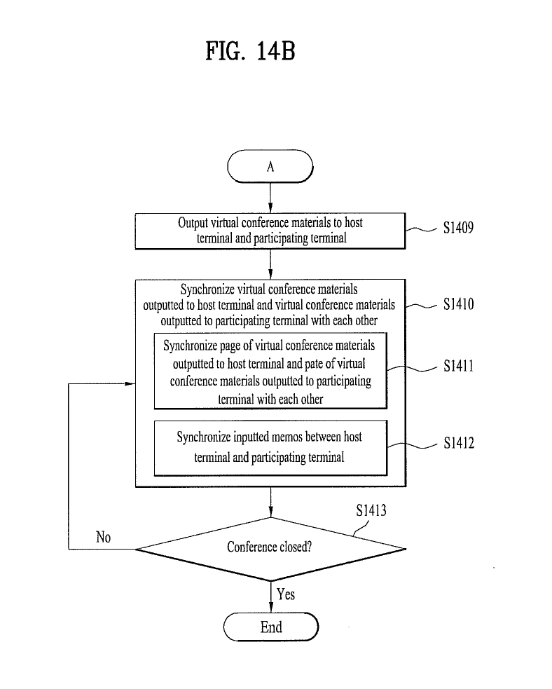

FIG. 14A and FIG. 14B are flowcharts of a method of controlling a virtual conference system according to one embodiment of the present invention.

Referring to FIG. 14A and FIG. 14B, in a step S1401, a host terminal 100-1 can be corrected to participating terminals 100-2, 100-3, 100-4 and the like by wireless.

In a step S1402, the host terminal 100-1 transmits an attendance request signal to the participating terminals 100-2, 100-3, 100-4 and the like. In this case, the attendance request signal may include a conference start time information.

In a step S1403, the host terminal 100-1 can receive an accept signal from the participating terminal in response to the attendance request signal.

In a step S1404, the host terminal 100-1 transmits virtual conference materials to the participating terminals 100-2, 100-3, 100-4 and the like before a conference start time.

If the virtual conference materials are modified in a step S1405, the host terminal 100-1 transmits the modified matters to the participating terminals 100-2, 100-3, 100-4 and the like in a step S1406. This is because the modified virtual conference materials need to be updated. Hence, in a step S1407, each of the participating terminals 100-2, 100-3, 100-4 and the like updates the downloaded virtual conference materials by reflecting the modified matters received from the host terminal 100-1.

In a step S1408, the host terminal 100-1 and the participating terminals 100-2, 100-3, 100-4 and the like enter a step S1409 by determining whether it is the conference start time.

In the step S1409, the host terminal 100-1 and the participating terminals 100-2, 100-3, 100-4 and the like output the virtual conference materials to the display units 151 of their own. Thus, the virtual conference materials respectively outputted from the terminals can be synchronized with each other in a step S1410. In doing so, the synchronization of the virtual conference materials can be performed in a manner that a page of the virtual conference materials outputted from the host terminal 100-1 is synchronized with pages of the virtual conference materials outputted from the participating terminals 100-2, 100-3, 100-4 and the like in a step S1411. And, memo data inputted to the host terminal 100-1 and memo data inputted to each of the participating terminals 100-2, 100-3, 100-4 and the like can be synchronized with each other in a step S1412.

In a step S1413, the host terminal 100-1 and the participating terminals 100-2, 100-3, 100-4 and the like determine whether the conference is closed. If the conference is not closed, the host terminal 100-1 and the participating terminals 100-2, 100-3, 100-4 and the like can repeat the step S1410 for the synchronization of the virtual conference materials.

Accordingly, embodiments of the present invention provide various effects and/or features.

According to at least one of embodiments of the present invention, virtual conference materials can be shared between mobile terminals participating in a virtual conference in advance of a conference time.

According to at least one of embodiments of the present invention, in sharing virtual conference materials between mobile terminals participating in a virtual conference, if the virtual conference materials are modified or memos are inputted to the virtual conference materials, the materials-synchronized and/or memo-synchronized virtual conference materials can be shared.

It will be appreciated by those skilled in the art that the present invention can be specified into other form(s) without departing from the spirit or scope of the inventions.

The above-described methods can be implemented in a program recorded medium as computer-readable codes. The computer-readable media may include all kinds of recording devices in which data readable by a computer system are stored. The computer-readable media may include ROM, RAM, CD-ROM, magnetic tapes, floppy discs, optical data storage devices, and the like for example and also include carrier-wave type implementations (e.g., transmission via Internet). Further, the computer may include the controller 180 of the terminal.

It will be appreciated by those skilled in the art that various modifications and variations can be made in the present invention without departing from the spirit or scope of the inventions. Thus, it is intended that the present invention covers the modifications and variations of this invention provided they come within the scope of the appended claims and their equivalents.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A mobile terminal to perform a virtual conference with a host terminal, the mobile terminal comprising:
a touchscreen;
a wireless communication unit to transceive data with the host terminal;
a memory to store virtual conference materials; and
a controller to receive, from the host terminal, an attendance request signal that includes information on a conference start time, and the controller to initiate a download of the virtual conference materials prior to the conference start time.

2. The mobile terminal of claim 1, further comprising a user input unit to receive an accept input of the received attendance request signal, and the controller to initiate the download of the virtual conference materials in response to the received accept input.

3. The mobile terminal of claim 1, wherein the attendance request signal includes at least one of an issue, an agenda, a host, a participant list, a date and a data size of the virtual conference, and wherein the controller to determine a time for initiating the download of the virtual conference materials based on the data size or a current data transceiving speed.

4. The mobile terminal of claim 1, wherein the controller to receive, from the host terminal, modified features of the virtual conference materials, and the controller to update the stored virtual conference materials based on the received modified features.

5. The mobile terminal of claim 1, wherein the controller to automatically perform the virtual conference at the conference start time.

6. The mobile terminal of claim 1, further comprising a user input unit to receive an input at a virtual conference access time, and the controller to automatically perform the virtual conference at the virtual conference access time.

7. The mobile terminal of claim 1, wherein when the virtual conference starts, the controller to control the virtual conference materials to be output at the touchscreen.

8. The mobile terminal of claim 7, wherein the virtual conference materials are output at the touchscreen of the mobile terminal by being synchronized with the virtual conference materials currently outputted from the host terminal.

9. The mobile terminal of claim 8, wherein the controller does not synchronize the virtual conference materials output at the touchscreen in the course of receiving an input via the touchscreen or within a prescribed time from a time of completing the receiving of the input.

10. The mobile terminal of claim 8, wherein when the virtual conference materials currently outputted from the host terminal are modified in the course of receiving an input at the touchscreen, the controller to stop the synchronization of the virtual conference materials, and wherein when receiving a prescribed input via the touchscreen, the controller to resume the stopped synchronization of the virtual conference materials in response to the prescribed input.

11. The mobile terminal of claim 7, wherein the controller to control an information input by one of a plurality of conference participating terminals to be displayed on a layer overlaying the outputted virtual conference materials, and wherein the controller to control the layer to be separately displayed or saved for each of the conference participating terminals.

12. The mobile terminal of claim 8, wherein the virtual conference materials include at least one content, wherein the controller to receive a content identification information via the wireless communication unit in the course of the virtual conference, and wherein the controller to control a content corresponding to the content identification information to be output in a manner of being identifiable from other contents in the virtual conference materials outputted to the touchscreen based on the received content identification information.

13. A host terminal to perform a virtual conference with a mobile terminal, comprising:
a touchscreen;
a wireless communication unit to transceive data with the mobile terminal;
a memory to store virtual conference materials; and
a controller to transmit, to the mobile terminal, an attendance request signal that includes information on a conference start time, and the controller to initiate a transmission of the virtual conference materials to the mobile terminal prior to the conference start time.

14. The host terminal of claim 13, wherein in response to receiving, from the mobile terminal, an accept signal corresponding to the attendance request signal, the controller to initiate an upload of the virtual conference materials.

15. The host terminal of claim 14, wherein the controller to modify the virtual conference materials based on an input via the touchscreen, and wherein the controller to control the wireless communication unit to transmit, to the mobile terminal, modified features of the modified virtual conference materials.

16. The host terminal of claim 13, wherein when the virtual conference starts, the controller to control the virtual conference materials to be output at the touchscreen.

17. The host terminal of claim 16, wherein the controller to control an information input by one of a plurality of conference participating terminals to be displayed on a layer overlaying the outputted virtual conference materials, and wherein the controller to control the layer to be separately displayed or saved for each of the conference participating terminals.

18. The host terminal of claim 16, wherein the controller to transmit, to the mobile terminal, synchronization information of the outputted virtual conference materials.

19. The host terminal of claim 14, wherein the virtual conference materials includes at least one content, wherein the controller to determine a content of a virtual conference in progress from among contents configured in the virtual conference materials based on an input via the touchscreen, and wherein the controller to control the wireless communication unit to transmit, to the mobile terminal, a content identification information for identifying the determined content.

20. A method of performing a virtual conference between a host terminal and a mobile terminal, the method comprising:
wirelessly connecting the host terminal and the mobile terminal;
transmitting, from the host terminal to the mobile terminal, an attendance request signal that includes information on a conference start time; and
transmitting, from the host terminal to the mobile terminal, virtual conference materials prior to the conference start time.

21. The method of claim 20, further comprising receiving, at the mobile terminal, an accept input of the received attendance request signal, and initiating the download of the virtual conference materials in response to the received accept input.

22. The method of claim 20, further comprising transmitting, at the host terminal, modified features of the virtual conference materials, and updating, at the mobile terminal, the virtual conference materials stored at the mobile terminal based on the modified features.

23. The method of claim 20, further comprising receiving an input at a virtual conference access time, and automatically performing the virtual conference at the virtual conference access time.

24. The method of claim 20, further comprising outputting the virtual conference materials at the touchscreen after being synchronized with the virtual conference materials being currently outputted by the host terminal.

25. A method of performing a virtual conference between a host terminal and a mobile terminal, comprising:
wirelessly connecting the host terminal and the mobile terminal;
receiving, at the mobile terminal, an attendance request signal that includes information on a conference start time; and
receiving, at the mobile terminal, saved virtual conference materials prior to the conference start time.

26. The method of claim 25, further comprising receiving an accept input of the received attendance request signal, and initiating the receiving of the virtual conference materials in response to the received accept input.

27. The method of claim 25, further comprising receiving, from the host terminal, modified features of the virtual conference materials, and updating the virtual conference materials stored at the mobile terminal based on the received modified features.

28. The method of claim 25, further comprising receiving an input at a virtual conference access time, and automatically performing the virtual conference at the virtual conference access time.

29. The method of claim 25, further comprising outputting the virtual conference materials at the touchscreen after being synchronized with the virtual conference materials being currently outputted by the host terminal.
